(19) United States
(12) Patent Application Publication
(10) Pub. No.: US 2007/0198701 A1
(43) Pub. Date: Aug. 23, 2007

(54) System And Method For Tracking Contents Via Internet

(75) Inventors: Marius Pindra, Paris (FR); Stephane Prevost, Lille (FR); Piolatto Thierry, Paris (FR)

Correspondence Address: YOUNG & THOMPSON, 745 SOUTH 23RD STREET, 2ND FLOOR, ARLINGTON, VA, 22202, US

(73) Assignee: GLOBAL INTERFACE, PARIS (FR)

(21) Appl. No.: 11/578,970

(22) PCT Filed: Apr. 19, 2005
(86) PCT No.: PCT/FR05/00960

§ 371 Date: Oct. 18, 2006

(30) Foreign Application Priority Data
Apr. 19, 2004 (FR) 0404124

(51) Int. Cl. G06F 15/173; G06F 17/00; G07G 1/00

(52) U.S. Cl. 709/224; 709/226; 715/513; 705/10

(57) ABSTRACT

A system for tracking syndicated contents via an Internet communications system includes a syndication server for transmitting a plurality of contents, at least one client's server for receiving the totality of contents transmitted by the syndication server and for transmitting the thus received contents to web pages, a tractability server for forming for each content an identifier in the form of the function of the client's server and the content, wherein the identifier is transmitted during downloading, a module agent, a module loaded into each web page visualized by a user, wherein the web page contains at least one of the contents and the associated identifier, in as much as the web page is activated, each loaded module detects and transmits a totality of advisory information and the identifier associated with the content of the web page to the associated agent module.

This invention relates to a system and a method for tracking electronic contents over an internet type communications network, these contents being intended for syndication. The content can be “news”, articles, etc.

The syndication of contents consists in distributing publication data stored in a database of a syndication server, a sort of content wholesaler. Distribution is carried out from a server either by FTP or by mail (attachment). The client receives syndicated contents in text, HTML or XML format. The client offers these contents to individuals over the internet.

The client possesses a server making it possible to retrieve data managed by the syndication server, to produce an output format (TXT, HTML, XML) and to offer it to users interested in the content. The contents can be broadcasted over the internet in three types of formats:
text format (TXT) managed by a file server,
XML format managed by an application server, and
HTML format managed by a web server.

The HTML format is intended to be visible to all internet users.

The purpose of this invention is the tracking of the broadcasted contents.

This purpose is achieved with a system for tracking electronic contents over an internet type communications network, these contents being intended for syndication, this system comprising:
a syndication server for broadcasting a plurality of contents;
at least one client server for receiving a set of contents sent by the syndication server and for broadcasting the thus-received contents within web pages;
a tracking server for creating, for each content, an identifier which is a function of said client server and of this content, said identifier being sent during downloading;
an agent module;
an embedded module in each web page viewed by a user, this web page containing at least one of said contents and the associated identifier, each embedded module being able to detect, as long as the web page is active, and to send to the associated agent module a set of consultation information as well as the identifier associated with the content present in this web page.

With the system according to the invention, the consultation information is retrieved together with identifiers previously developed by the tracking server. It is then possible to associate each item of information with the corresponding content because each identifier refers to a given content.

According to the invention, the agent is an application which can be housed within the tracking server, within the client server or within any server which can be accessed by the tracking server.

According to an advantageous characteristic of the invention, the tracking server periodically retrieves, from the agent, said set of consultation information together with the identifier.

By way of a non-limitative example, said set of consultation information comprises the clicks of a pointer such as a computer mouse as well as the browsing time of this pointer. Other event-driven information can be recorded as a function of the parametrization of the embedded module.

In a more precise manner, the embedded module can be a javascript module or a java module which is called up or activated by the content present in the corresponding web page. The embedded module can also be a java module coupled with a javascript module. Advantageously, the embedded module retrieves the consultation information as long as the content is displayed.

Preferably, the identifier associated with a content is inserted into the web page within a marker which is not interpreted by the web navigators but by said embedded module.

According to an advantageous characteristic of the invention, the system also comprises a statistical database containing for each content and for each client having received this content, criteria for transmission of this content; the tracking server being able to update said statistical database using said set of consultation information together with the identifier. This information makes it possible to verify whether the transmission criteria are always respected and to produce statistics.

By way of example, the embedded module and the agent can constitute a client-server application called an applet/servlet.

According to another feature of the invention, a method is proposed for tracking electronic contents over an internet type communications network, these contents being intended for syndication.

According to the invention, this method comprises the following steps:

sending a uploading request by the syndication server to a client server in order to broadcast a set of contents to a client server;
creating by a tracking server, for each content intended to be sent, an identifier which is a function of said client server and of this content,
downloading said set of contents as well as the associated identifiers, from the syndication server to the client server;
from the client server, making web pages available, each web page containing at least one content and the associated identifier as well as an embedded module;
on a web page viewed by a user, as long as the web page is active, storing by said embedded module of a set of consultation information and each identifier associated with each content present in this web page,
sending of the data thus stored by the embedded module to an agent; and
downloading said data from the agent to the tracking server.

Said data can be sent by the embedded module either in real time or when the corresponding web page is closed.

In addition to the above, before downloading said set of contents from the syndication server to the client server, there is stored in a statistical database criteria for transmission of each content downloaded by said client server, then said transmission criteria are updated using the consultation information and the identifier obtained by the embedded module.

Other advantages and characteristics of the invention will become apparent on examining the detailed description of an embodiment which is in no way limitative and the attached drawings, in which:

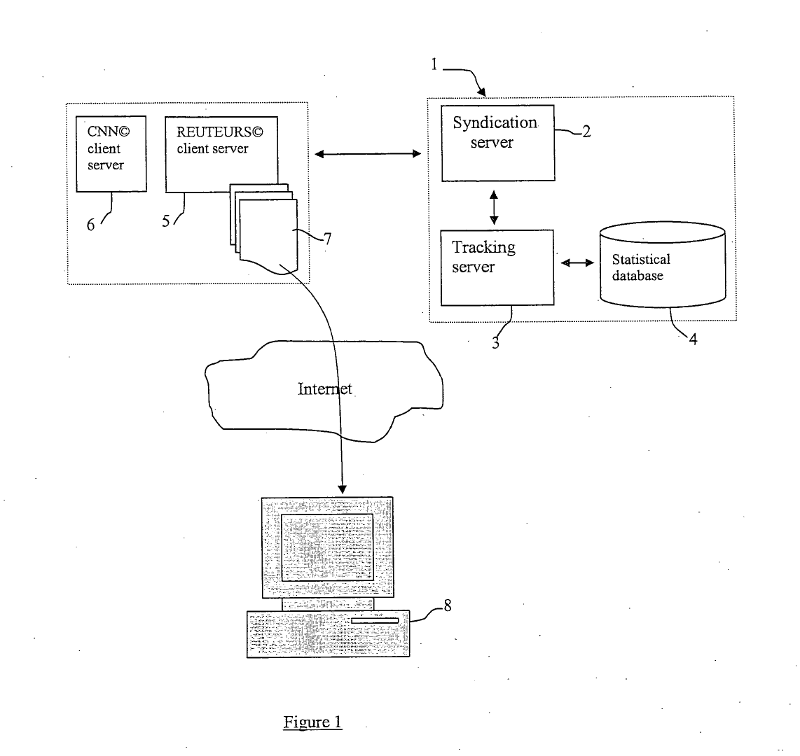

FIG. 1 is a general diagrammatic view of the system according to the invention;

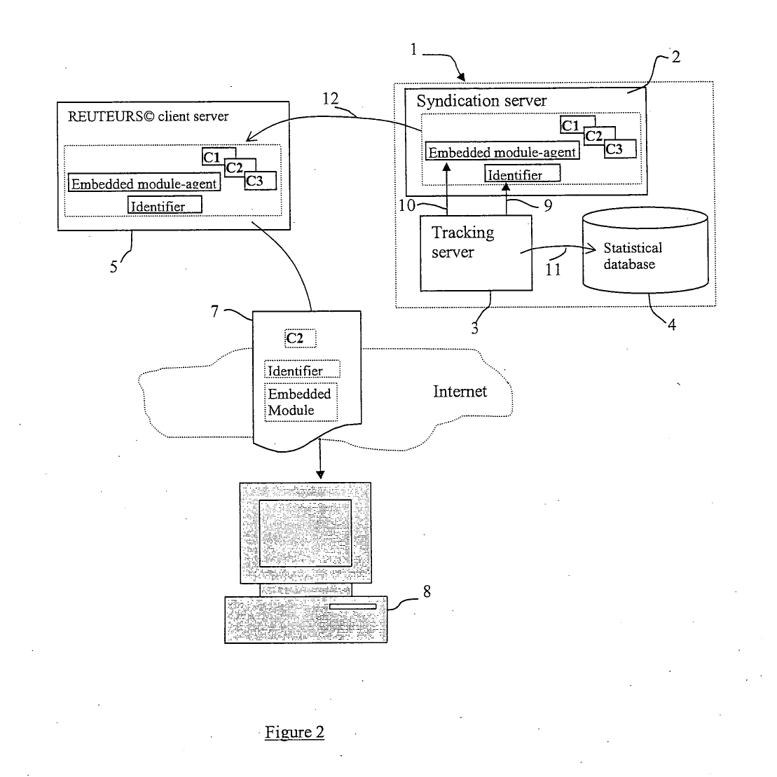

FIG. 2 is a diagrammatic view of the system of FIG. 1 showing the transfers of the application modules; and

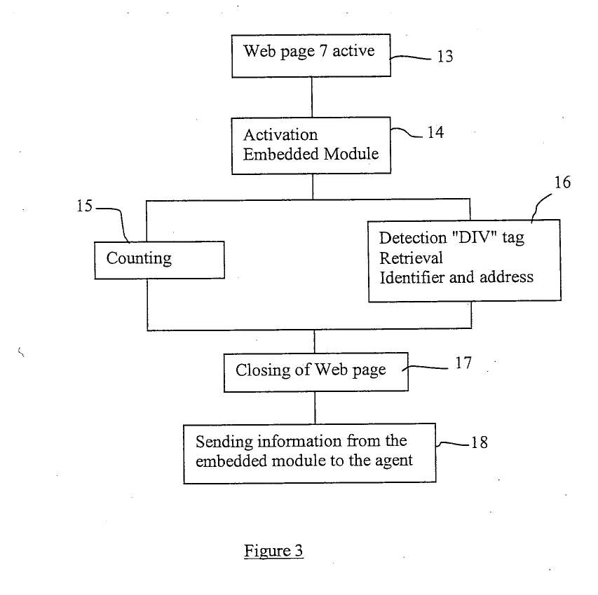

FIG. 3 is a diagram illustrating a few steps of the tracking method according to the invention.

A publication site 1 composed of a syndication server 2 containing contents such as news and articles and a tracking server 3 for managing the tracking method according to the invention are shown in FIG. 1. The tracking server also controls the statistical database 4 containing criteria for transmission of the contents of the syndication server 2. These contents are uploaded to the clients 5 and 6 for presentation in the form of web pages within internet sites of said clients.

The clients are media resellers such as for example CNN® or REUTERS®.

A user with a computer 8 can thus connect over the internet to the web site of the client 5 in order to view web pages 7 containing at least one of said contents.

The tracking consists in retrieving the consultation information and associating them with the broadcasted contents.

When a client 5 for example orders a set of contents c1, c2 and c3, see FIG. 2, from the syndication server 2, the tracking server 3 retrieves the characteristics of the order, principally the details of the client 5 and the references of the contents ordered. This tracking server then generates in

step 9, for each content, an identifier which is a function of the reference of this content and the reference of this client 5. This identifier is therefore a single key identifying a content for a given client. In step 10, the tracking server inserts into the packet which will be sent to the client 5 an embedded module associated with an agent. However it can be envisaged to insert only the embedded module, the agent remaining housed in the tracking server or elsewhere. It is also possible to use a client-server application the “client” part of which is called an applet and the “server” part of which is called a servlet.

In parallel in step 11, the tracking server records in the statistical database 4 the criteria for transmission of each content, i.e. the rights and privileges (type, validity, periodicity) associated with each content for a given client.

In step 12, the client 5 therefore receives the packet of ordered contents, c1, c2 and c3, as well as the identifier and the embedded module-agent pair.

When a user using his computer 8 equipped with an internet browser wishes to view the content c2 for example, the client 5 creates and sends a web page 7 containing this content as well as the associated identifier. Advantageously, the client 5 also sends the embedded module in the web page 7.

More specifically, the identifier is inserted into the web page 7 in the form of a tag or a marker known as “DIV” and containing the identifier in text form as well as the address of the agent corresponding to the embedded module. This marker is not interpreted by the internet browser but by the embedded module.

Different steps carried out when the user downloads the web page 7 to his browser will now be described with reference to FIG. 3. In step 13, the web page 7 is displayed on the browser. As soon as the content c2 is displayed, it calls up the embedded module in step 14 using javascript. Then, during the entire display time of the content c2, i.e. during step 15, the embedded module records the operations carried out by the user. The operation of recording the information consists in updating counters concerning the consultation information such as:
page-focussing time (browsing time),
number of links used from the page,
length of time an item of information has retained the focus,
number of clicks on an item of information, and
link used to access the information.

In parallel to step 15, the embedded module detects during step 16 the “DIV” marker so as to retrieve the identifier of the content c2 as well as the address of the agent.

As soon as the web page 7 is closed in step 17, the embedded module sends the set of recorded information to the agent during step 18. In other words, each time that the embedded module loses the focus, it sends the information to the corresponding agent. The latter retrieves the new information in order to carry out the following operations:
updating the consultation information, and
verification of the number of items of information stored and optionally triggering an alarm.

In order to transfer this information to the agent, the embedded module has a client-server interface with the agent present in the syndicated packet stored with the client 5. The information stored in the agent are periodically retrieved by the tracking server so as to update the statistical database by

associating the consultation information and the corresponding contents. Between the agent and a statistical server managing the database, an interface is created in particular using the “Remote_Method_Invocation” command of the java language in order to simplify any processing before insertion into the statistical database.

The tracking is carried out by associating the content and consultation information. When the tracking server receives the information coming from the agent, it carries out the following operations:
processing in preparation for insertion into the statistical database; this processing consists in structuring the transferred information and associating this structure and the identifier of the content, and
insertion into the statistical database by generating an SQL query for example.

As has been seen above, the use of an appropriate command in java language allows this first operation to be avoided.

When the embedded module is a java module alone, the latter can implement the functionalities of a web browser. The HTML pages are no longer viewed by the browser but by the java module. In this case this java module manages the keyboard/mouse events and is therefore able to retrieve the consultation data just as a javascript module would do.

This invention therefore allows the tracking of syndicated contents. The principle consists in recovering statistical information and storing it in order to be able to analyze it. An application of the client-server type is used, the “client” part being an embedded module responsible for retrieving the consultation information.

Of course the invention is not limited to the examples which have just been described and numerous adjustments can be made to these examples without exceeding the scope of the invention.

1. System for tracking electronic contents over an internet type communications network, these contents being intended for syndication, this system comprising:
a syndication server for broadcasting a plurality of contents;
at least one client server for receiving a set of contents sent by the syndication server and for broadcasting the thus-received contents within web pages;
a tracking server for creating, for each content, an identifier which is a function of said client server and of this content, said identifier being sent during downloading;
an agent module;
an embedded module in each web page viewed by a user, this web page containing at least one of said contents and the associated identifier, each embedded module being able to detect, as long as the web page is active, and to send to the associated agent module a set of consultation information as well as the identifier associated with the content present in this web page.

2. System according to claim 1, characterized in that the agent is an application housed within the tracking server.

3. System according to claim 1, characterized in that the agent is an application housed within the client server.

4. System according to claim 1, characterized in that the tracking server periodically retrieves said set of consultation information and the identifier from the agent.

5. System according to claim 1, characterized in that said set of consultation information comprises the clicks of a pointer such as a computer mouse as well as the browsing times of this pointer.

6. System according to claim 1, characterized in that the embedded module is a javascript module which is called up by the content present in the corresponding web page.

7. System according to claim 1, characterized in that the embedded module is a java module which is called up by the content present in the corresponding web page.

8. System according to claim 1, characterized in that the identifier associated with a content is inserted into the web page in a marker which is not interpreted by the web browsers but by said embedded module.

9. System according to claim 1, characterized in that it also comprises a statistical database containing for each content and for each client having received this content, criteria for transmission of this content; the tracking server being able to update said statistical database using said set of consultation information and the identifier.

10. System according to claim 1, characterized in that the embedded module and the agent constitute a client-server application called an applet/servlet.

11. Method for tracking electronic contents over an internet type communications network, these contents being intended for syndication, this method comprising the following steps:
sending a uploading request by the syndication server to a client server in order to broadcast a set of contents to a client server;
creating by a tracking server, for each content intended to be sent, an identifier which is a function of said client server and of this content,
downloading said set of contents as well as the associated identifiers, from the syndication server to the client server;
from the client server, making web pages available, each web page containing at least one content and the associated identifier as well as an embedded module;
on a web page viewed by a user, as long as the web page is active, storing by said embedded module of a set of consultation information and each identifier associated with each content present in this web page,
sending of the data thus stored by the embedded module to an agent; and
downloading said data from the agent to the tracking server.

12. Method according to claim 11, characterized in that said data are sent by the embedded module in real time.

13. Method according to claim 11, characterized in that said data are sent by the embedded module when the corresponding web page is closed.

14. Method according to claim 11, characterized in that before downloading of said set of contents from the syndication server to the client server, there is stored in a statistical database criteria for transmission of each content downloaded by said client server, then said transmission criteria are updated using consultation data and the identifier obtained by the embedded module.

15. Method according to claim 11, characterized in that the embedded module and the agent constitute a client-server application called an applet/servlet.

16. Method according to claim 12, characterized in that said data are sent by the embedded module when the corresponding web page is closed.

17. Method according to claim 12, characterized in that before downloading of said set of contents from the syndication server to the client server, there is stored in a statistical database criteria for transmission of each content downloaded by said client server, then said transmission criteria are updated using consultation data and the identifier obtained by the embedded module.

18. Method according to claim 13, characterized in that before downloading of said set of contents from the syndication server to the client server, there is stored in a statistical database criteria for transmission of each content downloaded by said client server, then said transmission criteria are updated using consultation data and the identifier obtained by the embedded module.

19. Method according to claim 12, characterized in that the embedded module and the agent constitute a client-server application called an applet/servlet.

20. Method according to claim 13, characterized in that the embedded module and the agent constitute a client-server application called an applet/servlet.
